(19) United States
(12) Patent Application Publication
(10) Pub. No.: US 2008/0311032 A1
(43) Pub. Date: Dec. 18, 2008

(54) Method of manufacturing aluminum oxide (Al2O3) substrate

(76) Inventor: Tsung-Ting Sun, Chung-Ho City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/976,472

(22) Filed: Oct. 25, 2007

(30) Foreign Application Priority Data
Jun. 13, 2007 (TW) 096121377

(51) Int. Cl. C01F 7/04

(52) U.S. Cl. 423/625

(57) ABSTRACT

A method of manufacturing aluminum oxide (Al₂O₃) substrate is disclosed. In this method, an aluminum planking is provided first, and then proceeding a chemical reaction is proceeded on the surface of the aluminum planking to form an Al₂O₃ layer, and finally, the aluminum oxide layer is separated from the aluminum planking by corroding the aluminum portion of the aluminum planking with chemical solution, grinding the aluminum portion or slicing the aluminum portion.

### BACKGROUND OF THE INVENTION

(a) Field of the Invention

The present invention is related to manufacture an aluminum oxide (Al₂O₃) substrate, and more particularly related to a method of manufacturing an Al₂O₃ substrate by using an aluminum planking directly.

(b) Description of the Prior Art:

Oxide artificial lattice has very important applications in modem technological products. For example, aluminum oxide is a highly suitable substrate material for gallium nitride, which makes its growth technology particularly important. The key technology for growing aluminum oxide substrate is the melting of aluminum oxide powder in 2000° C. environment to have it sintered into crystalline structure. Sintering is a critical process, in which, the control of oven temperature determines the quality of sapphire crystal. The instability of the oven temperature tends to result in poor crystal quality.

Known processes for high-temperature sintering of aluminum oxide substrate are both expensive and time consuming, which often result in poor crystalline structure due to unstable control of temperature. As aluminum oxide is used extensively in the packaging structure of light-emitting diode as LED substrate, the availability of low-cost or simple process for forming aluminum oxide substrate with certain thickness presents a pressing problem.

To address the drawbacks of prior art, the inventor, based on many years of research, development and practical experiences, proposes a method of manufacturing Al₂O₃ substrate as basis for implementing the improvement of prior art.

### SUMMARY OF THE INVENTION

Briefly, it is a primary object of the present invention to provide a method of manufacturing Al₂O₃ substrate by using a simple chemical process to form Al₂O₃ on aluminum planking.

A method of manufacturing Al₂O₃ substrate in accordance with present invention comprises the following steps of:

Providing an aluminum planking;

Proceeding a chemical reaction on the surface of the aluminum planking to form an aluminum oxide layer on it ; and

Separating the aluminum oxide layer from the aluminum planking.

Preferably, the step of separating the aluminum oxide layer from the aluminum layer can comprise physical destruction means and chemical corrosion means.

### BRIEF DESCRIPTION OF THE DRAWINGS

The subject matter regarded as the invention is particularly pointed out and distinctly claimed in the concluding portion of the specification. The invention with features and advantages thereof may best be understood by reference to the following detailed description with the accompanying drawings in which:

FIG. 1 is a flow diagram of the method of manufacturing Al₂O₃ substrate in accordance with the present invention;

FIG. 2A is a schematic view of an embodiment of the method of manufacturing Al₂O₃ substrate in accordance with the present invention;

FIG. 2B is a schematic view of other embodiment of the method of manufacturing Al₂O₃ substrate in accordance with the present invention; and

FIG. 2C is a schematic view of another embodiment of the method of

### DETAILED DESCRIPTION OF THE PREFERRED EMBODIMENTS

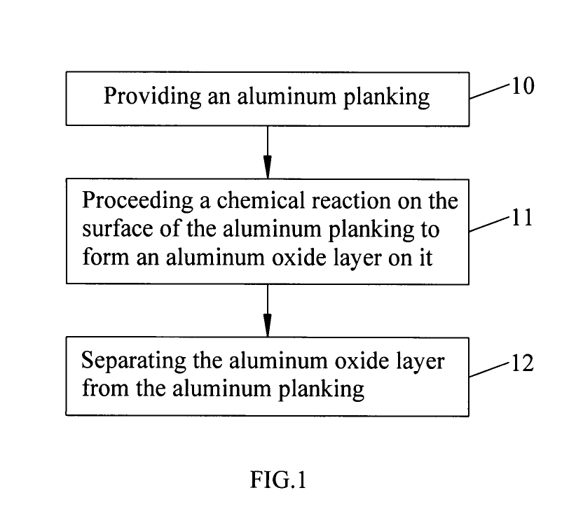

Please referring to FIG. 1 for a flow diagram of a method of manufacturing Al₂O₃ substrate in accordance with present invention, the method comprises the following steps:

Step 10: Providing an aluminum planking, preferably, the aluminum planking can be an aluminum board or an aluminum foil.

Step 11: Proceeding a chemical reaction on the surface of the aluminum planking to form an aluminum oxide layer on it;

The aluminum is a strong reductant, so the surface of the aluminum planking will be oxidized rapidly and form an oxide film about fifty angstroms in thickness in the normal temperature environment with dry air. Because of this aluminum oxide film, the aluminum planking can resist the water corrosion from advanced oxidation.

The chemical reaction can be performed by a mercury-aluminum amalgam process. The aluminum can react with water to generate the aluminum oxide while mercury salt and mercury oxide exist. In the other embodiment, the aluminum can be oxidized directly in the air to generate the aluminum oxide while mercury exists.

2Al+6H2O→Al2O3+3H2+3H2O

4Al+3O₂→2Al₂O₃

In another embodiment, the aluminum oxide can be generated by reacting the ferric oxide by a redox process. However, this process must be performed in a high temperature environment and is applied in smelting frequently.

2Al₍ₛ₎+Fe₂O₃₍ₛ₎→2Fe₍ₛ₎+Al₂O₃₍ₛ₎ΔH=−849 Kj

Step. 12: Separating the aluminum oxide layer from the aluminum planking. This step can be realized by at least three separation means which are described in the following.

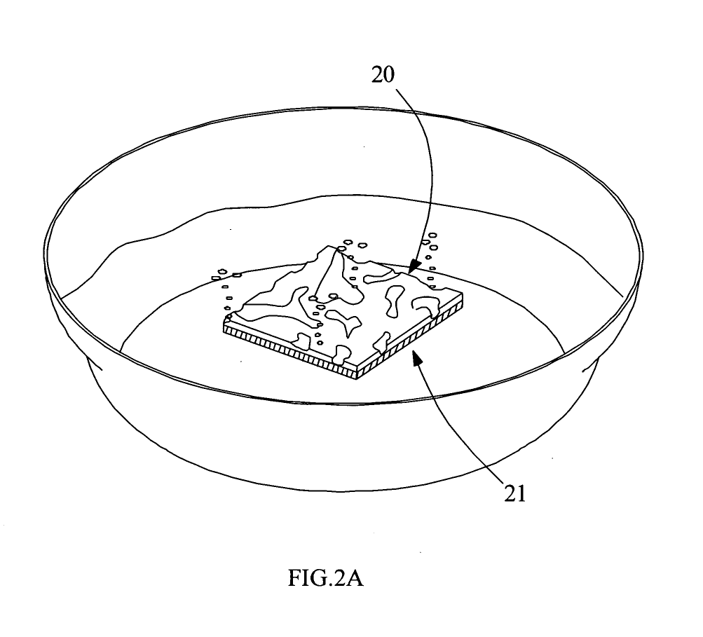

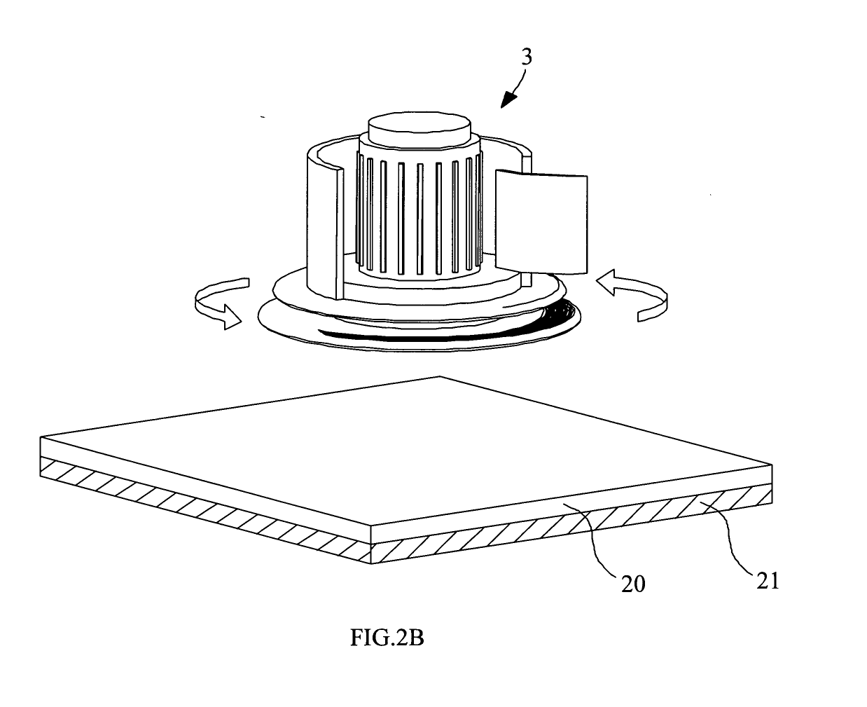

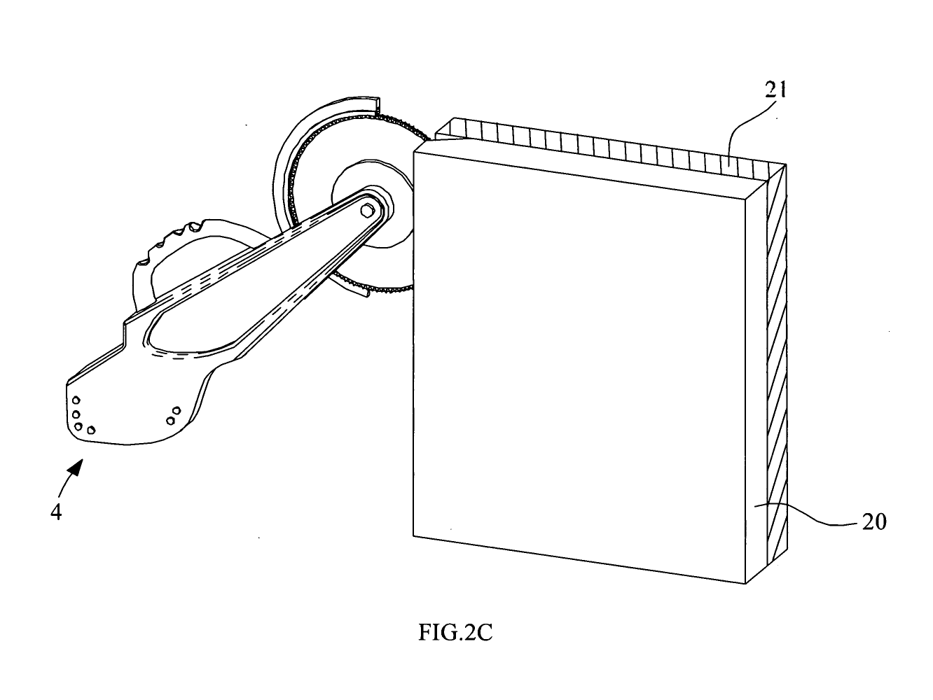

Please referring to FIG. 2A for a schematic view of an embodiment of the method of manufacturing Al2O3 substrate in accordance with present invention, the separation means of this embodiment is to corrode an aluminum portion 20 of aluminum planking for removing the aluminum portion 20 and obtaining the oxidized portion 21 of the aluminum planking.

The aluminum is an amphiprotic metal which can react with both diluted acid and strong base, so the aluminum can be dissolved in strong base solution easily to generate aluminate and hydrogen gas, and the aluminum also can be dissolved in diluted acid solution easily to generate a corresponding aluminate and hydrogen gas. The following chemical formulas can be applied in the present invention.

2Al+2OH⁻+6H₂O→2Al(OH)₄⁻+3H₂

2Al+6H₃O⁺→2Al(H₂O)₆³⁺3H₂

However, if the purity of the aluminum is higher, the reacting rate with acid becomes slower. The pure aluminum with purity beyond 99.95% can only be dissolved in aqua regia. Besides, the surface of aluminum will be passivated when the aluminum is soaked in cold concentrated sulfuric acid or concentrated nitric acid. Hence, the preferred solution for corroding aluminum is a strong base such as sodium hydrogen (NaOH) solution or potassium hydrogen (KOH) solution and so on.

Besides, the preferred solution for corroding aluminum also can be an etchant of copper chloride which is composed of copper chloride and hydrogen acid. When the aluminum planking is soaked in this solution, the displacement reaction occurs between the copper ion in the etchant of copper chloride and aluminum, and the copper ion would be transformed into copper powder and elemental aluminum would be transformed into aluminum ion, so the aluminum portion can be removed from the aluminum planking.

Please referring to FIG. 2B for a schematic view of other embodiment of the method of manufacturing Al₂O₃ substrate in accordance with the present invention, the separation means of this embodiment is to grind the aluminum planking for removing the aluminum portion 20 of the aluminum planking in physical destruction. The separation means can be performed by a polisher 3, such as a grinder or a polishing machine. In addition, this separation means can be processed simultaneously with the corrosion, like the chemical mechanical polishing.

Please referring to FIG. 2C for a schematic view of another embodiment of the method of manufacturing Al₂O₃ substrate in accordance with present invention, the separation means of this embodiment is to slice the aluminum planking for obtaining oxidized portion 21. This separation means can be performed by using a cutting machine 4, such as a plasma arc cutting apparatus, a laser cutting machine, a grinder cutting machine, a water cutting apparatus or a diamond cutting apparatus and so on.

It is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

What is claimed is,

1. A method of manufacturing an Al₂O₃ substrate, comprising the steps of:
providing an aluminum planking;
proceeding a chemical reaction on the surface of said aluminum planking to form an aluminum oxide layer on said surface; and
separating said aluminum oxide layer from said aluminum planking.

2. The method of claim 1, wherein said aluminum planking comprises an aluminum board or an aluminum foil.

3. The method of claim 1, wherein said step of separating comprises a step of corroding said aluminum planking for removing the aluminum portion of said Al₂O₃ substrate.

4. The method of claim 3, wherein said step of corroding said aluminum planking is performed by a mercury-aluminum amalgam process or a redox process.

5. The method of claim 1, wherein said step of separating comprises a step of grinding said aluminum planking for removing the aluminum portion of said Al₂O₃ substrate.

6. The method of claim 5, wherein said step of grinding said aluminum planking is performed by using a grinder or a polishing machine.

7. The method of claim 1, wherein said step of separating comprises a step of slicing said aluminum planking for removing the aluminum portion of said Al₂O₃ substrate.

8. The method of claim 7, wherein said step of slicing said aluminum planking is performed by using a plasma arc cutting apparatus, a laser cutting machine, a grinder cutting machine, a water cutting apparatus or a diamond cutting apparatus.
